(19) United States
(12) Patent Application Publication
(10) Pub. No.: US 2024/0069580 A1
(43) Pub. Date: Feb. 29, 2024

(54) CONTROLS ARCHITECTURE FOR PREDICTING AND MAINTAINING CO2 UPTAKE RATES IN DIRECT AIR CAPTURE CONTACTORS, AND METHODS OF OPERATING THE SAME

(71) Applicant: Heirloom Carbon Technologies, Inc., Brisbane, CA (US)

(72) Inventors: Andy DUBEL, Moss Beach, CA (US); Aaron NEWMAN, San Francisco, CA (US); Robert DUNCAN, San Francisco, CA (US); Jennifer MILLS, San Leandro, CA (US); Scott OLSON, San Francisco, CA (US); Isabel GUEBLE, Sunnyvale, CA (US); Ruofei LIU, San Jose, CA (US); Noah MCQUEEN, San Francisco, CA (US)

(21) Appl. No.: 18/239,201

(22) Filed: Aug. 29, 2023

Related U.S. Application Data
(60) Provisional application No. 63/402,211, filed on Aug. 30, 2022.

(51) Int. Cl. G05D 22/02; G01W 1/10

(52) U.S. Cl. CPC G05D 22/02; G01W 1/10

(57) ABSTRACT

In some aspects, a method of carbonation control can include monitoring, via a first sensor, an environmental condition in a contactor unit, the contactor unit including a plurality of carbonation vessels including carbonation medium, monitoring, via a second sensor, an environmental condition at a location outside of the contactor unit, predicting, based on the measured environmental condition in the contactor unit and the measured environmental condition at the location outside of the contactor unit, a local humidity in a carbonation vessel from the plurality of carbonation vessels, a water content of the carbonation medium in the carbonation vessel from the plurality of carbonation vessels, and a carbonation extent of the carbonation medium in the carbonation vessel from the plurality of carbonation vessels for a carbonation forecasting period, and executing an action on the plurality of carbonation vessels based on the predicted water content and predicted carbonation extent.

### CROSS-REFERENCE TO RELATED APPLICATIONS

This application claims priority to U.S. Provisional Application No. 63/402,211, filed Aug. 30, 2022, and titled “Controls Architecture for Predicting and Maintaining CO₂ Uptake Rates in Direct Air Capture Contactors, and Methods of Operating the Same,” the disclosure of which is hereby incorporated by reference in its entirety.

### TECHNICAL FIELD

Embodiments described herein relate to control systems and methods for predicting and maintaining CO₂ uptake rates in an automated system.

### BACKGROUND

The atmospheric concentration of CO₂ has reached 410 parts per million by volume (ppm), an increase of almost 20 ppm in the last 10 years. As current emission levels exceed 35 GtCO₂/year, a diverse portfolio of CO₂ mitigation technologies must be developed and strategically deployed to avoid a 2° C. increase in Earth's average surface temperature by 2100. Due to global reliance on fossil fuels, this portfolio must include technologies that can remove current and future CO₂ emissions from the atmosphere, some of which include the acceleration of natural processes such as the CO₂ uptake of oceans and the terrestrial biosphere (soils, forests, minerals), bioenergy with carbon capture and storage (BECCS), and synthetic approaches using chemicals also known as direct air capture with storage (DACS) technologies. For DACS technologies based on the passive carbonation of oxide and hydroxide minerals, inclusion of moisture in the air capture medium can improve the uptake of CO₂. Efficiency of water delivery to the carbonation medium affects the overall efficiency of a system employing a carbonation medium. A system can be implemented to control the delivery of water to the carbonation medium and improve its efficiency.

### SUMMARY

Embodiments described herein relate to control systems for controlling the moisture content of a carbonation medium, and methods of predicting and maintaining CO₂ uptake rates in an automated system. In some aspects, a method can include monitoring, via a first sensor, an environmental condition in a contactor unit, the contactor unit including a plurality of carbonation vessels including carbonation medium, monitoring, via a second sensor, environmental conditions at a location outside of the contactor unit, predicting, based on the environmental condition in the contactor unit and the environmental condition at the location outside of the contactor unit, a local relative humidity in a carbonation vessel from the plurality of carbonation vessels, a moisture content of the carbonation medium in the carbonation vessel from the plurality of carbonation vessels, and a carbonation extent of the carbonation medium in the carbonation vessel from the plurality of carbonation vessels for a carbonation forecasting period, and executing an action on the plurality of carbonation vessels based on the predicted moisture content and/or predicted carbonation extent.

In some embodiments, the method can further include receiving, at a processor, current weather data from a weather service provider, wherein predicting the moisture content and carbonation extent of the carbonation medium is based on the current weather data. In some embodiments, the method can further include receiving, at the processor, weather forecast data from a forecast provider, wherein predicting the moisture content and carbonation extent of the carbonation medium is based on the weather forecast data. In some embodiments, the action can include at least one of spraying water into the carbonation vessel, increasing humidity in the carbonation vessel, delivering water to the carbonation vessel via capillary action and/or capillary mats, stirring the carbonation medium in the carbonation vessel, dumping the carbonation medium from the carbonation vessel, or filling the carbonation vessel with carbonation medium. In some embodiments, the forecasting period can be between about 1 hour and about 48 hours. In some embodiments, the weather service provider and the forecast provider can be the same provider. In some embodiments, the location outside of the contactor unit can be within about 50 m of an outside border of the contactor unit. In some embodiments, the weather forecast data can be for a period of about 1 hour to about 96 hours.

### BRIEF DESCRIPTION OF THE DRAWINGS

FIG. 1 is a flow diagram of a method of controlling water delivery to a carbonation medium, according to an embodiment.

FIG. 2 is a block diagram of a system for controlling water delivery to a carbonation medium, according to an embodiment.

FIG. 3 is a block diagram of a system for controlling water delivery to a carbonation medium, according to an embodiment.

FIG. 4 is a block diagram of a computing cluster for controlling water delivery to a carbonation medium, according to an embodiment.

FIG. 5 is a block diagram of a system for controlling water delivery to a carbonation medium, according to an embodiment.

FIG. 6 is an entity relationship diagram of a system for controlling water delivery to a carbonation medium, according to an embodiment.

### DETAILED DESCRIPTION

Embodiments described herein relate to controls architecture for water delivery to a carbonation medium and maintenance of CO₂ uptake rates in an automated fashion. The controls architecture can be used to control carbonation vessel (e.g., tray) processing inside of a contactor system. In some embodiments, trays and contactor units described herein can be the same or substantially similar to those described in U.S. patent application Ser. No. 18/348,112 (“the '112 application”), filed Jul. 6, 2023, and titled, “Direct Air Capture Contactor for Carbon Uptake, and Methods of Operating the Same,” the disclosure of which is hereby incorporated by reference in its entirety.

Carbonation vessels described herein can be processed using a distributor (i.e., a processing unit). A controls system can take in environmental data from sensors integrated into a contactor, sensors that are distributed throughout a process cell, as well as predictive data from weather forecasts to anticipate when and how a tray should be processed. In some embodiments, this prediction is then prioritized and used to create a schedule for processing trays. In some embodiments, a tray processing instruction can be generated when a distributor approaches a tray. For example, a central processing unit (CPU) can send a tray processing instruction to the distributor when the distributor is in close proximity to the tray. Processing can include spraying, increasing local humidity in the carbonation vessel, delivering water to the carbonation vessel via capillary action and/or capillary mats, taking measurements using a distributor (or other similar hardware), stirring, or other actions or combinations thereof.

Embodiments described herein provide a basis for tray processing, carbonation, and moisture control, as well as predicting carbonation extent and moisture content. An array of sensors can be provided both outside and inside the contactors that are continuously collecting environmental data that is fed into an environmental data localizer. The environmental data localizer determines environmental conditions of specific trays and groups of trays using algorithms described herein. The information from the environmental data localizer is sent to the modeler. The modeler can also receive information from weather forecast services (among other external data sources) as well as information on latest estimates for the state of a tray (i.e., predicted carbonation extent and moisture content). Using this information, the modeler can determine a current calculated moisture content and a predicted future moisture content for the carbonation medium for a given carbonation vessel.

In some embodiments, the carbonation medium can include at least one of calcium oxide, calcium hydroxide, magnesium oxide, magnesium hydroxide, sodium oxide, sodium hydroxide, or dolomitic lime (calcium-magnesium oxide or hydroxide). Carbonation rate can be a function of moisture content in the carbonation medium as well as other environmental factors and material properties. This information can be used to determine when the moisture content will be sufficiently low to hamper carbonation rate, and when the carbonation extent of the tray will approach a specified threshold at which the carbonation medium is deemed ready to be emptied form the carbonation vessel. In some embodiments, the carbonation extent threshold value can range from about 50% to about 100% carbonation.

The prediction from the modeler can be used to inform the system's next action via a planner. The planner can receive updated estimates from the modeler for a tray and translates the estimate into a schedule of tray operations in the form of a list of conditions. Tray operations can include commands, such as spray, deliver water via capillary action, humidify, dump, fill, measure, stir, or any combination thereof. Prior to outputting a carbonation vessel schedule, the schedule is constrained by the availability of shared machinery for each contactor. After developing a schedule, the planner can send the schedule to a conductor gateway via a request (e.g., an HTTP POST request). The conductor gateway is a routing layer that maintains a mapping between a carbonation vessel and a contactor, using mapping to dispatch schedules received for a tray to the responsible conductor via a request (e.g., an HTTP POST request).

In an example embodiment, a distributor can visit each tray in the contactor sequentially and execute the following for each tray: (1) execute load cell measurement of tray mass; (2) provide the load cell measurement to a modeler via an HTTP POST request along with data (e.g., weather forecasting data, state-of-tray data, as described above), which the modeler uses to calculate carbonation extent (%) and the mass or water to add to the tray; (3) if the carbonation extent is sufficiently high, the conductor can (3a) move the tray to a caddy to be picked up for collection; otherwise the conductor can (3b) request that the tray is operated upon using one of the aforementioned methods (i.e., spray, deliver water via capillary action, humidify, dump, fill, measure, stir, or any combination thereof). The conductor can also choose to take no action.

Embodiments described herein enable high CO₂ uptake rates in carbonation medium irrespective of environmental conditions (i.e., effective control of carbonation rates). Embodiments described herein also enable tracking and prediction of carbonation extent (i.e., CO₂ uptake via carbonation medium) and moisture content in order to precisely time the transfer of carbonation medium to a carbonation regeneration subsystem.

Embodiments described herein can also enable control of water use and subsequently minimize water use in the carbonation system. The level of precision and control of water delivery enables greater efficiency and allows for more optimization than modern irrigation systems. Additionally, all-in-one weather stations can calculate predicted evaporation rates, but do not include a feedback loop to process a material or give a command to a piece of physical infrastructure. Predicted evaporation rates can be calculated based on specific characteristics of the carbonation medium. In other words, a range of different carbonation media can be accounted for in the development of the modeling of the carbonation system. They additionally do not include an environmental data localizer.

In some embodiments, the carbonation medium and/or the contactors described herein can have any of the properties described in International Patent Publication No. 2020/263910 (“the '910 publication”), filed Jun. 24, 2020, and titled, “Systems and Methods for Enhanced Weathering and Calcining for CO₂ Removal from Air,” the disclosure of which is hereby incorporated by reference in its entirety. In some embodiments, the carbonation medium and/or the contactors described herein can have any of the properties described in International Patent Application No. US2022/018484 (“the '484 application”), filed Mar. 2, 2022, and titled, “Systems and Methods for Enhanced Weathering and Calcining for CO₂ Removal from Air,” the disclosure of which is hereby incorporated by reference in its entirety. Benefits of interactions between water and carbonation medium are described in greater detail in the '910 publication and the '484 application.

As used herein, “carbonation plot,” includes single contiguous plots, as well as semi- or non-contiguous plots that are then grouped or processed together to effectively act as a single plot. In some embodiments, carbonation plots include a composition that sequesters a target compound (e.g., CO₂). In some embodiments, carbonation plots are positioned and configured to expose the composition to ambient conditions. In some embodiments, carbonation plots can include a composition that sequesters a target compound.

As used herein, “stream” can refer to stream that includes solid, liquid, and/or gas. For example, a stream can include a solid in granular form conveyed on a conveyor device. A stream can also include a liquid and/or gas flowing through a pipe. A stream can include a solution.

As used in this specification, the singular forms “a,” “an,” and “the” include plural referents unless the context clearly dictates otherwise. Thus, for example, the term “a member” is intended to mean a single member or a combination of members, “a material” is intended to mean one or more materials, or a combination thereof.

The term “substantially” when used in connection with “cylindrical,” “linear,” and/or other geometric relationships is intended to convey that the structure so defined is nominally cylindrical, linear or the like. As one example, a portion of a support member that is described as being “substantially linear” is intended to convey that, although linearity of the portion is desirable, some non-linearity can occur in a “substantially linear” portion. Such non-linearity can result from manufacturing tolerances, or other practical considerations (such as, for example, the pressure or force applied to the support member). Thus, a geometric construction modified by the term “substantially” includes such geometric properties within a tolerance of plus or minus 5% of the stated geometric construction. For example, a “substantially linear” portion is a portion that defines an axis or center line that is within plus or minus 5% of being linear.

As used herein, the term “set” and “plurality” can refer to multiple features or a singular feature with multiple parts. For example, when referring to a set of contactors, the set of contactors can be considered as one contactor with multiple portions, or the set of contactors can be considered as multiple, distinct contactors. Thus, a set of portions or a plurality of portions may include multiple portions that are either continuous or discontinuous from each other. A plurality of particles or a plurality of materials can also be fabricated from multiple items that are produced separately and are later joined together (e.g., via mixing, an adhesive, or any suitable method).

As used herein, the term “about” and “approximately” generally means plus or minus 10% of the value stated, e.g., about 250 μm would include 225 μm to 275 μm, about 1,000 μm would include 900 μm to 1,100 μm.

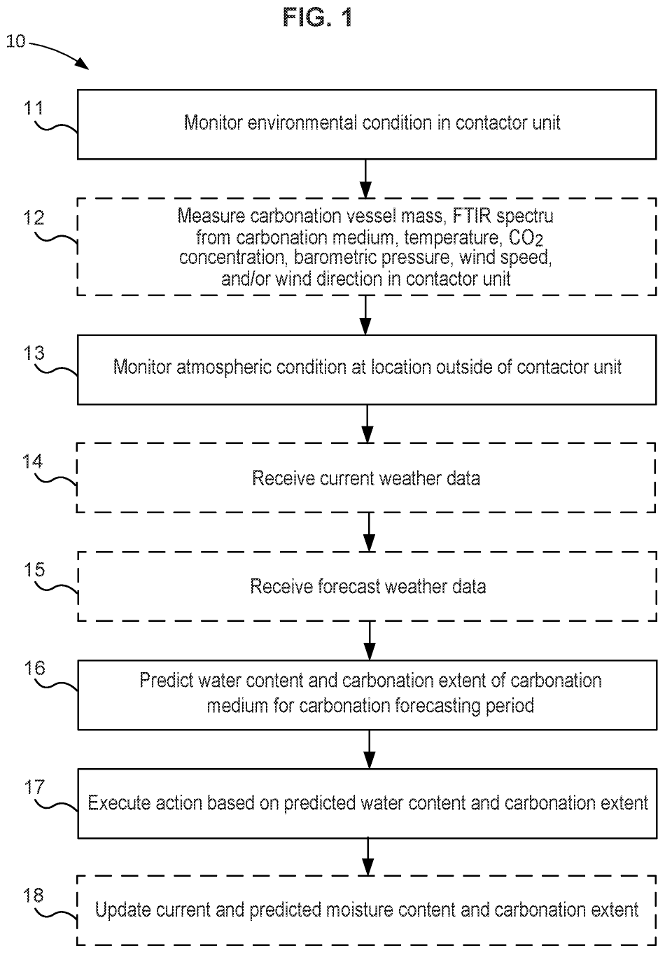

FIG. 1 is a flow diagram of a method 10 of controlling water delivery to a carbonation medium, according to an embodiment. As shown, the method 10 includes monitoring an atmospheric condition in a contactor unit at step 11. The method 10 optionally includes measuring carbonation vessel mass, Fourier Transform Infrared (FTIR) spectroscopy from the carbonation medium, temperature, CO₂ concentration, barometric pressure, solar radiation and irradiance, wind speed, gust speed, and/or wind direction in the contractor unit at step 12. The method 10 further includes monitoring an atmospheric condition at a location outside of the contactor unit at step 13. The method 10 optionally includes receiving current weather data at step 14 and receiving forecasted weather data at step 15. The method 10 further includes predicting the moisture content and the carbonation extent of the carbonation medium for a carbonation forecasting period at step 16 and executing an action based on the predicted moisture content and carbonation extent at step 17. The method 10 optionally includes updating the predicted moisture content and carbonation extent at an update interval at step 18.

Step 11 includes monitoring an environmental condition in the contactor unit. In some embodiments, the environmental condition can include relative humidity. In some embodiments, the environmental condition can include temperature in the contactor unit, CO₂ concentration in the contactor unit, barometric pressure in contractor unit, solar radiation and irradiance, wind speed, and/or wind direction in the contactor unit. In some embodiments, the monitoring can include measurement of the relative humidity via a sensor. In some embodiments, the contactor unit can be exposed to the surrounding or outside environment. In some embodiments, the contactor unit can be contained or isolated from the surrounding environment. In some embodiments, “in the contactor unit” can refer to locations within the bounds created by bars of the contactor unit. For example, the region in the contactor unit can be between minimum and maximum x, y, and z values occupied by bars that form the contactor unit. In some embodiments, “in the contactor unit” can refer to a location within a specified distance of a center of gravity of the carbonation vessels. In some embodiments, the specified distance can be about 10 cm, about 20 cm, about 30 cm, about 40 cm, about 50 cm, about 60 cm, about 70 cm, about 80 cm, about 90 cm, about 1 m, about 2 m, about 3 m, about 4 m, about 5 m, about 6 m, about 7 m, about 8 m, about 9 m, or about 10 m, inclusive of all values and ranges therebetween.

In some embodiments, “in the contactor unit” can refer to a location within a specified distance of outer edges of the carbonation vessels. In some embodiments, the specified distance can be about 5 cm, about 10 cm, about 20 cm, about 30 cm, about 40 cm, about 50 cm, about 60 cm, about 70 cm, about 80 cm, about 90 cm, about 1 m, about 2 m, about 3 m, about 4 m, or about 5 m, inclusive of all values and ranges therebetween. In some embodiments, the relative humidity in the contactor unit can be monitored via a capacitive humidity sensor, a resistive humidity sensor, and/or a thermal humidity sensor. In some embodiments, a single sensor or measurement system can be used to monitor a plurality of contactors. For example, a sensor can be placed within a specified distance (e.g., about 5 cm, about 10 cm, about 20 cm, about 30 cm, about 40 cm, about 50 cm, about 60 cm, about 70 cm, about 80 cm, about 90 cm, about 1 m, about 2 m, about 3 m, about 4 m, or about 5 m, inclusive of all values and ranges therebetween) of the outer edge of multiple carbonation vessels, and can make predictions about each of the carbonation vessels.

Step 12 is optional and includes measuring the carbonation vessel mass, FTIR from the carbonation medium, temperature in the contactor unit, CO₂ concentration in the contactor unit, barometric pressure in contractor unit, solar radiation and irradiance, wind speed, and/or wind direction in the contactor unit. In some embodiments, the measurement can be from a sensor or instrumentation, different from the sensor used to measure relative humidity. In some embodiments, multiple sensors (i.e., with different sensing capabilities such as CO₂ concentration and relative humidity) can be housed in one location or one housing. In some embodiments, mass can be measured via a scale placed below each carbonation vessel. In some embodiments, mass can be measured via a moving scale that can be placed under one carbonation vessel at a time. In some embodiments, the scale can be placed at a central location (e.g., inside of a distributor).

In some embodiments, the measurements of a single tray can be used to make predictions about a cohort of trays (e.g., about 2 trays, about 3 trays, about 4 trays, about 5 trays, about 6 trays, about 7 trays, about 8 trays, about 9 trays, about 10 trays, about 20 trays, about 30 trays, about 40 trays, about 50 trays, about 60 trays, about 70 trays, about 80 trays, about 90 trays, or about 100 trays, inclusive of all values and ranges therebetween). In other words, a single tray can be measured (e.g., weighed) at a centralized location and used as a proxy for multiple trays.

In some embodiments, infrared instrumentation (e.g., FTIR) can be used to determine the chemical makeup and various concentrations of compounds in the carbonation medium. In some embodiments, an infrared spectral sensor can be used to determine the composition of the carbonation medium. In some embodiments, temperature can be measured in a carbonation vessel and/or the contactor unit via a thermocouple. In some embodiments, temperature can be measured in a carbonation vessel and/or the contactor unit via a thermometer. In some embodiments, CO₂ concentration can be measured in a carbonation vessel and/or the contactor unit via an ambient gas sensor. In some embodiments, barometric pressure can be measured in a carbonation vessel and/or the contactor unit via a barometer. In some embodiments, the wind speed can be measured via an anemometer.

At step 13, the method 10 includes monitoring an atmospheric condition at a location outside of the contactor unit. In some embodiments, the atmospheric condition can include relative humidity. In some embodiments, the relative humidity can be monitored via a sensor, different from the sensor used to monitor relative humidity inside the contactor unit. In some embodiments, the location outside of the contactor unit can be measured from a boundary between the inside of the contactor unit and the outside of the contactor unit, as described above with reference to step 11, where “in the contactor unit” refers to physical boundaries created by imaginary lines extending from bars of the contactor unit. In some embodiments, the location outside of the contactor unit can be measured from the center of gravity of a carbonation vessel. In some embodiments, the location outside of the contactor unit can be measured from the external bounds of a carbonation vessel. In some embodiments, the atmospheric condition monitored at step 13 can include temperature, CO₂ concentration, solar irradiance, barometric pressure, wind speed, gust speed, wind direction, or any combination thereof.

In some embodiments, the location outside of the contactor unit can be at least about 1 m, at least about 2 m, at least about 3 m, at least about 4 m, at least about 5 m, at least about 6 m, at least about 7 m, at least about 8 m, at least about 9 m, at least about 10 m, at least about 20 m, at least about 30 m, at least about 40 m, at least about 50 m, at least about 60 m, at least about 70 m, at least about 80 m, or at least about 90 m from the boundary, the center of gravity of the carbonation vessel, or the external bounds of the carbonation vessel. In some embodiments, the location outside of the contactor unit can be no more than about 100 m, no more than about 90 m, no more than about 80 m, no more than about 70 m, no more than about 60 m, no more than about 50 m, no more than about 40 m, no more than about 30 m, no more than about 20 m, no more than about 10 m, no more than about 9 m, no more than about 8 m, no more than about 7 m, no more than about 6 m, no more than about 5 m, no more than about 4 m, no more than about 3 m, or no more than about 2 m from the boundary, the center of gravity of the carbonation vessel, or the external bounds of the carbonation vessel.

Combinations of the above-referenced distances are also possible (e.g., at least about 1 m and no more than about 100 m or at least about 5 m and no more than about 60 m), inclusive of all values and ranges therebetween. In some embodiments, the location outside of the contactor unit can be about 1 m, about 2 m, about 3 m, about 4 m, about 5 m, about 6 m, about 7 m, about 8 m, about 9 m, about 10 m, about 20 m, about 30 m, about 40 m, about 50 m, about 60 m, about 70 m, about 80 m, about 90 m, or about 100 m from the boundary, the center of gravity of the carbonation vessel, or the external bounds of the carbonation vessel.

Step 14 is optional and includes receiving current weather data. The current weather data includes data from the geographic region where the contactor unit resides. In some embodiments, the current weather data can be from a local weather service provider. In some embodiments, the current weather data can be from a professional or commercial provider. In some embodiments, the current weather data can be collected independently (e.g., from instrumentation). In some embodiments, the current weather data can include temperature, humidity, precipitation, barometric pressure, solar radiation and irradiance, dewpoint, wind speed, and/or wind direction data.

In some embodiments, the current weather data can be received at regular intervals. In some embodiments, the current weather data can be received at irregular intervals. In some embodiments, the current weather data can be received at intervals of at least about 1 second, at least about 2 seconds, at least about 3 seconds, at least about 4 seconds, at least about 5 seconds, at least about 10 seconds, at least about 15 seconds, at least about 20 seconds, at least about 30 seconds, at least about 40 seconds, at least about 50 seconds, at least about 1 minute, at least about 5 minutes, at least about 10 minutes, at least about 15 minutes, at least about 20 minutes, at least about 30 minutes, at least about 40 minutes, at least about 50 minutes, at least about 1 hour, at least about 2 hours, at least about 3 hours, at least about 4 hours, at least about 5 hours, at least about 10 hours, at least about 12 hours, or at least about 18 hours. In some embodiments, the current weather data can be received at intervals of no more than about 24 hours, no more than about 18 hours, no more than about 12 hours, no more than about 10 hours, no more than about 5 hours, no more than about 4 hours, no more than about 3 hours, no more than about 2 hours, no more than about 1 hour, no more than about 50 minutes, no more than about 40 minutes, no more than about 30 minutes, no more than about 20 minutes, no more than about 15 minutes, no more than about 10 minutes, no more than about 5 minutes, no more than about 4 minutes, no more than about 3 minutes, no more than about 2 minutes, no more than about 1 minute, no more than about 50 seconds, no more than about 40 seconds, no more than about 30 seconds, no more than about 20 seconds, no more than about 15 seconds, no more than about 10 seconds, no more than about 5 seconds, no more than about 4 seconds, no more than about 3 seconds, or no more than about 2 seconds.

In some embodiments, the current weather data can be received at intervals of about 1 second, about 2 seconds, about 3 seconds, about 4 seconds, about 5 seconds, about 10 seconds, about 15 seconds, about 20 seconds, about 30 seconds, about 40 seconds, about 50 seconds, about 1 minute, about 5 minutes, about 10 minutes, about 15 minutes, about 20 minutes, about 30 minutes, about 40 minutes, about 50 minutes, about 1 hour, about 2 hours, about 3 hours, about 4 hours, about 5 hours, about 10 hours, about 12 hours, about 18 hours, or about 24 hours.

Step 15 is optional and includes receiving forecast weather data. In some embodiments, the forecast weather data can be from a local service provider. In some embodiments, the forecast weather data can be from a professional or commercial service provider. In some embodiments, the forecast weather data can be collected independently (e.g., from instrumentation provided). In some embodiments, the forecast weather data can be received from the same provider as the current weather data. In some embodiments, the forecast weather data can include temperature, relative humidity, precipitation, barometric pressure, solar radiation and irradiance, CO₂ concentration, dewpoint, wind speed, and/or wind direction forecast data. In some embodiments, the forecast weather data can forecast into the future by about 1 hour, about 4 hours, about 12 hours, about 1 day, about 2 days, about 3 days, about 4 days, about 5 days, about 6 days, about 7 days, about 8 days, about 9 days, about 10 days, about 11 days, about 12 days, about 13 days, about 14 days, or about 15 days, inclusive of all values and ranges therebetween.

In some embodiments, forecast weather data can be retrieved or refreshed at intervals of at least about 1 minute, at least about 5 minutes, at least about 10 minutes, at least about 15 minutes, at least about 20 minutes, at least about 30 minutes, at least about 40 minutes, at least about 50 minutes, at least about 1 hour, at least about 2 hours, at least about 3 hours, at least about 4 hours, at least about 5 hours, at least about 10 hours, at least about 12 hours, at least about 18 hours, at least about 1 day, at least about 2 days, at least about 3 days, at least about 4 days, at least about 5 days, or at least about 6 days. In some embodiments, the forecast weather data can be retrieved or refreshed at intervals of no more than about 7 days, no more than about 6 days, no more than about 5 days, no more than about 4 days, no more than about 3 days, no more than about 2 days, no more than about 1 day, no more than about 18 hours, no more than about 12 hours, no more than about 10 hours, no more than about 5 hours, no more than about 4 hours, no more than about 3 hours, no more than about 2 hours, no more than about 1 hour, no more than about 50 minutes, no more than about 40 minutes, no more than about 30 minutes, no more than about 20 minutes, no more than about 15 minutes, no more than about 10 minutes, no more than about 5 minutes, no more than about 4 minutes, no more than about 3 minutes, or no more than about 2 minutes.

Combinations of the above-referenced intervals are also possible (e.g., at least about 1 minute and no more than about 7 days or at least about 12 hours and no more than about 1 day), inclusive of all values and ranges therebetween. In some embodiments, forecast weather data can be retrieved or refreshed at intervals of about 1 minute, about 5 minutes, about 10 minutes, about 15 minutes, about 20 minutes, about 30 minutes, about 40 minutes, about 50 minutes, about 1 hour, about 2 hours, about 3 hours, about 4 hours, about 5 hours, about 10 hours, about 12 hours, about 18 hours, about 1 day, about 2 days, about 3 days, about 4 days, about 5 days, about 6 days, or about 7 days.

Step 16 includes predicting a moisture content and a carbonation extent of the carbonation medium for a carbonation forecasting period. Moisture content can be a function of predicted temperatures, humidity, solar radiation and irradiance, wind speed, barometric pressures, and CO₂ concentration, as well as current temperatures, humidity, solar radiation and irradiance, wind speed, barometric pressure, and CO₂ concentration. Moisture content may also be a function of material properties (such as surface area and particle size) as well as the material's carbonation and hydration state. In some embodiments, the predicting can be via a modeler software. Carbonation rate is a function of moisture content, as described in the '910 publication and the '484 application. A carbonation forecasting model predicts the future carbonation extent of the carbonation medium for a carbonation forecasting period. In some embodiments, the method 10 can include generating a schedule for application of water to one or more carbonation vessels based on the predicted moisture content and carbonation extent at step 16. In some embodiments, the schedule can include a movement plan for a distributor in the contactor unit.

In some embodiments, the carbonation forecasting period can be at least about 1 minute, at least about 5 minutes, at least about 10 minutes, at least about 15 minutes, at least about 20 minutes, at least about 30 minutes, at least about 40 minutes, at least about 50 minutes, at least about 1 hour, at least about 2 hours, at least about 3 hours, at least about 4 hours, at least about 5 hours, at least about 10 hours, at least about 12 hours, at least about 18 hours, at least about 1 day, at least about 2 days, at least about 3 days, at least about 4 days, at least about 5 days, at least about 6 days, at least about 7 days, at least about 10 days, at least about 15 days, at least about 20 days, or at least about 25 days. In some embodiments, the forecasting period can be no more than about 30 days, no more than about 25 days, no more than about 20 days, no more than about 15 days, no more than about 10 days, no more than about 7 days, no more than about 6 days, no more than about 5 days, no more than about 4 days, no more than about 3 days, no more than about 2 days, no more than about 1 day, no more than about 18 hours, no more than about 12 hours, no more than about 10 hours, no more than about 5 hours, no more than about 4 hours, no more than about 3 hours, no more than about 2 hours, no more than about 1 hour, no more than about 50 minutes, no more than about 40 minutes, no more than about 30 minutes, no more than about 20 minutes, no more than about 15 minutes, no more than about 10 minutes, or no more than about 5 minutes.

Combinations of the above-referenced carbonation forecasting periods are also possible (e.g., at least about 1 minute and no more than about 30 days or at least about 3 hours and no more than about 6 days), inclusive of all values and ranges therebetween. In some embodiments, the carbonation forecasting period can be about 1 minute, about 5 minutes, about 10 minutes, about 15 minutes, about 20 minutes, about 30 minutes, about 40 minutes, about 50 minutes, about 1 hour, about 2 hours, about 3 hours, about 4 hours, about 5 hours, about 10 hours, about 12 hours, about 18 hours, about 1 day, about 2 days, about 3 days, about 4 days, about 5 days, about 6 days, about 7 days, about 10 days, about 15 days, about 20 days, about 25 days, or about 30 days.

Step 17 includes executing an action based on a predicted moisture content and a predicted carbonation extent. In some embodiments, the action can include spraying a carbonation vessel, humidifying the carbonation vessel, delivering water to the carbonation vessel via capillary action and/or capillary mats, dumping carbonation medium from a carbonation vessel, filling a carbonation vessel with carbonation medium, measuring a mass of a carbonation vessel, taking an IR spectrum of the carbonation vessel, and/or stirring the carbonation medium in the carbonation vessel. In some embodiments, either of these actions can be scheduled at prescribed intervals in the future.

In some embodiments, spraying can include spraying of water into the carbonation vessel at prescribed times and/or with prescribed amounts in the future when the moisture content of the carbonation medium is predicted to fall below a threshold value. In some embodiments, the threshold value can be about 100 wt % water, about 95 wt % water, about 90 wt % water, about 85 wt % water, about 80 wt % water, about 75 wt % water, about 70 wt % water, about 65 wt % water, about 60 wt % water, about 55 wt % water, about 50 wt % water, about 45 wt % water, about 40 wt % water, about 35 wt % water, about 30 wt % water, about 25 wt % water, about 20 wt % water, about 15 wt % water, about 10 wt % water, about 9 wt % water, about 8 wt % water, about 7 wt % water, about 6 wt % water, about 5 wt % water, about 4 wt % water, about 3 wt % water, about 2 wt % water, about 1 wt % water, about 0.9 wt % water, about 0.8 wt % water, about 0.7 wt % water, about 0.6 wt % water, about 0.5 wt % water, about 0.4 wt % water, about 0.3 wt % water, about 0.2 wt % water, or about 0.1 wt % water, inclusive of all values and ranges therebetween. In some embodiments, the amount and/or frequency of water sprayed can be determined by a measured environmental condition, a forecasted environmental condition, a measured moisture content in the carbonation vessel, and/or a forecasted moisture content in the carbonation vessel.

In some embodiments, dumping the carbonation medium can be in response to the carbonation medium being spent (i.e., the carbonation medium is no longer taking up CO₂ and is mostly carbonate), such that the spent carbonation medium can be calcined. Dumping can also be in response to detecting that the carbonation vessel is over a desired weight. In some embodiments, stirring the carbonation medium can be in response to a predicted moisture content that is higher than a threshold value (due to forecasted rain or humidity) to aerate the carbonation medium. In some embodiments, the threshold value can be about 10 wt %, about 11 wt %, about 12 wt %, about 13 wt %, about 14 wt %, about 15 wt %, about 16 wt %, about 17 wt %, about 18 wt %, about 19 wt %, about 20 wt %, about 21 wt %, about 22 wt %, about 23 wt %, about 24 wt %, about 25 wt %, about 30 wt %, about 35 wt %, about 40 wt %, about 45 wt %, about 50%, about 55 wt %, or about 60 wt %, inclusive of all values and ranges therebetween. Stirring can also be in response to an overweight carbonation vessel in order to aerate the carbonation medium. Filling the carbonation vessel with carbonation medium can be in response to detecting that the carbonation vessel is less than a desired weight or to restart a cycle by depositing fresh sorbent material. In some embodiments, collected trays can be selected based on their carbonation extent. Trays with varying levels of carbonation extent can be collected. This “tray blending” can yield an aggregate material that meets or exceeds a target carbonation value (e.g., about 50% carbonation, about 55% carbonation, about 60% carbonation, about 65% carbonation, about 70% carbonation, about 75% carbonation, about 80% carbonation, about 85% carbonation, or about 90% carbonation, inclusive of all values and ranges therebetween) by blending over-carbonated and under-carbonated material.

Step 18 is optional and includes updating a current estimated moisture content, current estimated carbonation extent, forecasted moisture content, and forecasted carbonation extent at an update interval. In some embodiments, the update can be based on present environmental data. In some embodiments, the update can be based on forecast data. In some embodiments, the update interval can be at least about 1 minute, at least about 2 minutes, at least about 3 minutes, at least about 4 minutes, at least about 5 minutes, at least about 10 minutes, at least about 15 minutes, at least about 20 minutes, at least about 30 minutes, at least about 40 minutes, at least about 50 minutes, at least about 1 hour, at least about 2 hours, at least about 3 hours, at least about 4 hours, at least about 5 hours, at least about 10 hours, at least about 12 hours, or at least about 18 hours. In some embodiments, the update interval can be no more than about 24 hours, no more than about 18 hours, no more than about 12 hours, no more than about 10 hours, no more than about 5 hours, no more than about 4 hours, no more than about 3 hours, no more than about 2 hours, no more than about 1 hour, no more than about 50 minutes, no more than about 40 minutes, no more than about 30 minutes, no more than about 20 minutes, no more than about 15 minutes, no more than about 10 minutes, no more than about 5 minutes, no more than about 4 minutes, no more than about 3 minutes, or no more than about 2 minutes.

Combinations of the above-referenced update intervals are also possible (e.g., at least about 1 minute and no more than about 24 hours or at least about 5 minutes and no more than about 12 hours), inclusive of all values and ranges therebetween. In some embodiments, the update interval can be about 1 minute, about 2 minutes, about 3 minutes, about 4 minutes, about 5 minutes, about 10 minutes, about 15 minutes, about 20 minutes, about 30 minutes, about 40 minutes, about 50 minutes, about 1 hour, about 2 hours, about 3 hours, about 4 hours, about 5 hours, about 10 hours, about 12 hours, about 18 hours, or about 24 hours.

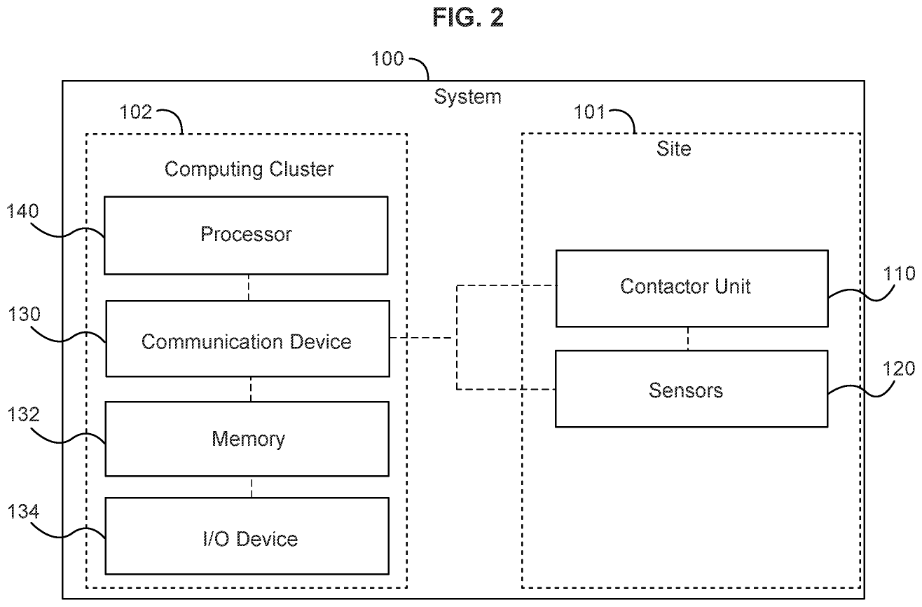

FIG. 2 is a block diagram of a system 100 for controlling water delivery to a carbonation medium, according to an embodiment. As shown, the system 100 includes a site 101 with carbonation equipment and a computing cluster 102 with computational hardware.

As shown, the site 101 includes a contactor unit 110 and sensors 120, while the computing cluster 102 includes a communication device 130, a memory 132, an Input/Output (I/O) device 134, and a processor 140. In some embodiments, the contactor unit 110 can have the same or substantially similar properties to those described in the '112 application. In some embodiments, the sensors 120 can include humidity sensors, temperature sensors, solar radiation and irradiance sensors, wind speed sensors, wind direction sensors, precipitation sensors, barometric pressure sensors, and/or CO₂ concentration sensors, as described above with reference to FIG. 1. In some embodiments, one or more of the sensors 120 can be coupled to the contactor unit 110. In some embodiments, one or more of the sensors 120 can be positioned outside of the contactor unit 110 and/or uncoupled from the contactor unit 110.

As shown, dotted connectors indicate a communicative coupling and solid connectors indicate solid coupling. In some embodiments, the communicative coupling can be via a Wi-Fi connection, a wired connection, a wireless connection, a 3G connection, a 4G connection, a 5G connection, or any other suitable communicative coupling or combinations thereof. In some embodiments, the computing cluster 102 can be physically located at the site 101 or in close proximity to the site 101. In some embodiments, the computing cluster 102 can be located at a separate location from the site.

As shown, the communication device 130 receives data from the contactor unit 110 and the sensors 120. In some embodiments, the data can include any of the environmental conditions described above with reference to FIG. 1 (e.g., temperature, humidity, barometric pressure, CO₂ concentration, solar radiation and irradiance, wind speed, wind direction, etc.). The communication device 130 communicates with the processor 140. The processor 140 then communicates instructions to the contactor unit 110 to execute operations (e.g., spray, humidify, deliver water via capillary action, dump, fill, measure, stir).

In some embodiments, the memory 132, can include a random-access memory (RAM), a memory buffer, a hard drive, a database, an erasable programmable read-only memory (EPROM), an electrically erasable read-only memory (EEPROM), a read-only memory (ROM), or any combination thereof. In some embodiments, memory 122 stores instructions that cause processor 140 to execute modules, processes, and/or functions associated with operating one or more components of the contactor unit 110. Such instructions can be designed to integrate specialized functions into a controller of the contactor unit 110, such that one or actions can be performed.

The I/O device 134 includes one or more components for receiving information and/or sending information to other components of computing cluster 102 and/or site 101. In some embodiments, the I/O device 134 can optionally include or be operatively coupled to a display, audio device, or other output device for presenting information to a user. In some embodiments, the I/O device 134 can include a communication interface that can enable communication between the communication device 130, the sensors 120, a power source, and/or the contactor unit 110. In some embodiments, the I/O device 134 can include a network interface that can enable communication between the computing cluster 102 and one or more external devices, including, for example, an external user device (e.g., a mobile phone, a tablet, a laptop) and/or other compute device (e.g., a local or remote compute, a server, etc.). The network interface can be configured to provide a wired connection with the external device, (e.g., via a port or firewall interface, can be configured to communicate with the external device via a wireless network).

The processor 140 can be any suitable processing device configured to run and/or execute functions associated with the contactor unit 110. For example, processor 140 can be configured to process and/or analyze sensor data (e.g., received from sensor(s) 120 coupled to and/or integrated into the contactor unit 110), to change the timing of stirring, spraying, humidifying, measuring, delivering water via capillary action, filling, dumping, to adjust one or more other parameters or aspects of contactor unit operation, etc. The processor 140 can be a general-purpose processor, a Field Programmable Gate Array (FPGA), an Application Specific Integrated Circuit (ASIC), a Digital Signal Processor (DSP), and/or the like.

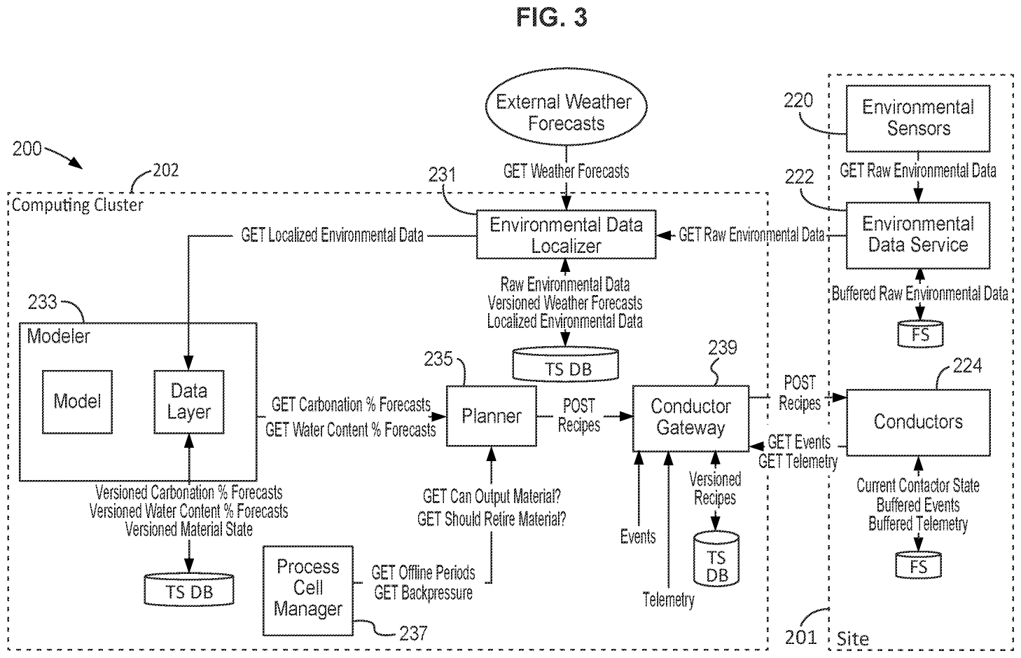

FIG. 3 shows a system 200 for controlling water delivery to a carbonation medium, according to an embodiment. As shown, the system 200 includes a site 201 with carbonation equipment and a computing cluster 202 with computational hardware. As shown, the site 201 includes environmental sensors 220, an environmental data service 222, and conductors 224. As shown, the computing cluster 202 includes an environmental data localizer 231, a modeler 233, a planner 235, a process cell manager 237, and a conductor gateway 239.

In some embodiments, the environmental sensors 220 can be the same or substantially similar to the sensors 120, as described above with reference to FIG. 2. As shown, the environmental sensors 220 transport raw environmental data to the environmental data service 222 (e.g., via a GET function). The raw environmental data is buffered via a filesystem (FS). The environmental data localizer 231 retrieves the raw environmental data via the environmental data service 222.

The environmental data localizer 231 shares raw environmental data, versioned weather forecasts, and localized environmental data with a time series database (TS DB), as well as retrieving raw environmental data, versioned weather forecasts, and localized environmental data from the TS DB. The environmental data localizer 231 retrieves weather forecasts from external weather forecasts (e.g., via a GET function). In some embodiments, the environmental weather forecasts can be from professional or commercial weather forecast providers. The environmental data localizer 231 feeds localized environmental data (i.e., present environmental data and forecasted weather data) to the modeler 233. The modeler 233 shares carbonation percentage forecasts, moisture content percentage forecasts, and material state (e.g., saturated carbonation medium, fresh carbonation medium) forecasts with a TS DB. In some embodiments, the material state data can include a ‘ready to empty’ flag. In addition, the modeler 233 receives carbonation percentage forecasts, moisture content percentage forecasts, and material state forecasts from the TS DB.

The modeler 233 feeds carbonation percentage forecasts and moisture content forecasts to the planner 235. The process cell manager 237 also feeds offline period data and backpressure data to the planner 235. The backpressure data is information conveyed by the process cell manager 237 to signal to the carbonation subsystem that the carbonation subsystem should reduce its output rate of carbonation medium. In other words, the backpressure data keeps the carbonation subsystem and the regeneration subsystem in balance. The process cell manager 237 is responsible for coordinating the operation of a carbonation subsystem with the operation of material handling and regeneration subsystems. For example, if the regeneration subsystem is unable to receive additional carbonated material, the process cell manager 237 notifies the planner 235 of the carbonation subsystem and the material handling subsystems to reduce output.

The planner 235 makes decisions about whether a quantity of carbonation medium should be retired (i.e., dumped and recycled for calcining). The planner 235 feeds recipes (i.e., sequences of steps enacted on the contactor unit) to the conductor gateway 239 via a POST command. The conductor gateway 239 communicates with a TS DB to develop versioned (i.e., tracked for possible evaluation later) recipes. The conductor gateway 239 feeds the recipes to the conductors 224 and receives event and data from the conductors 224 as well as from the environmental sensors. The conductors 224 are software programs that initiate actions to be performed on the trays (e.g., moving, dumping, measuring, filling, spraying, humidifying, deliver water via capillary action). The conductors 224 receive current contactor state information, as well as buffered event.

The conductor gateway 239 provides an abstraction layer between the conductor instances, which map 1-1 with PLC's, and other software programs that operate at the site 201. For example, the planner 235 can request information from any tray from the conductor gateway 239, regardless of which of the conductors 224 is responsible for the tray. When the conductor gateway 239 receives a request, it selects the conductor 224 that manages the requested information and forward the request to that particular conductor 224 instance. Once the response is received, the conductor gateway 239 returns the response to the planner 235.

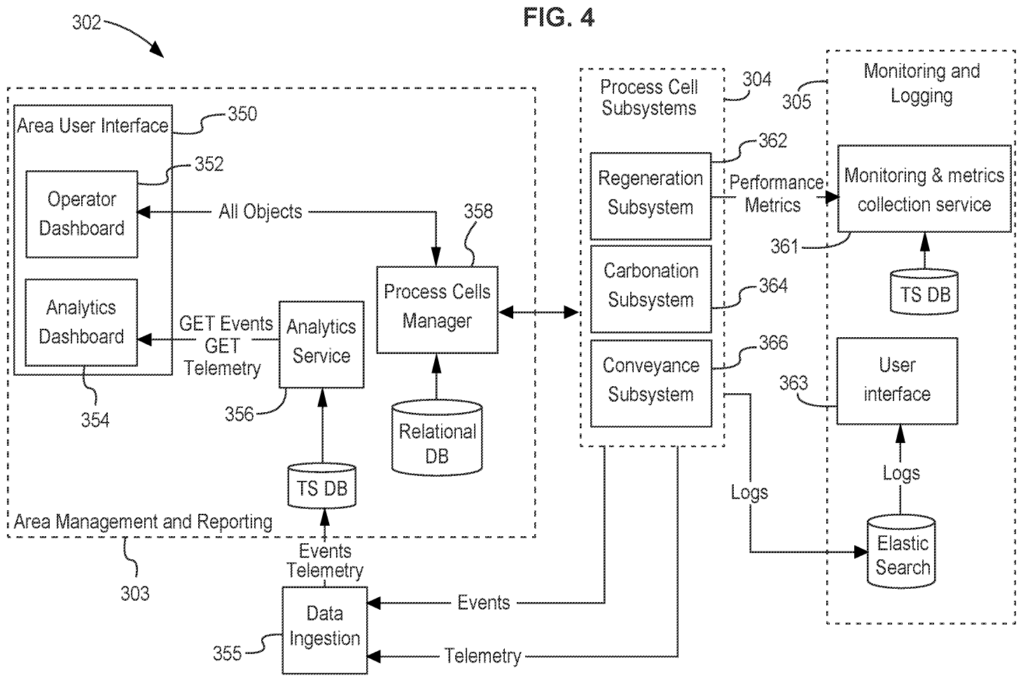

FIG. 4 shows a computing cluster 302 for controlling water delivery to a carbonation medium, according to an embodiment. As shown, the computing cluster 302 includes subclusters for area management and reporting 303, process cell subsystems 304, and monitoring and logging 305. The area management and reporting 303 subcluster includes an area user interface 350 with an operator dashboard 352 and an analytics dashboard 354. The management and reporting 303 subcluster further includes an analytics service 356 and a process cells manager 358. The process cell subsystems 304 include a regeneration subsystem 362, a carbonation subsystem 364, and a conveyance subsystem. The monitoring and logging 305 subsystem can include a monitoring and metrics collection service 361 and a data visualization and analytics service 363.

A user or operator can make system management decisions via the operator dashboard 352. The operator dashboard 352 can receive data from the process cells manager 358. The process cells manager 358 receives information from a relational database (DB). The analytics dashboard 354 can allow the user or operator to read data that is either raw or has been subject to processing by the analytics service 356. In some embodiments, the analytics dashboard can receive analyzed data from the analytics service 356. In some embodiments, the analytics service 356 can receive data from a TS DB. The TS DB can receive data from a data ingestion site 355, which receives data from the process cell subsystems 303.

In the process cell subsystems 303, the regeneration subsystem 362 makes decisions regarding whether to replace and/or replenish carbonation medium in a particular carbonation vessel (e.g., tray). The carbonation subsystem 364 produces data about carbonation and uptake. The conveyance subsystem 366 produces data about movement of carbonation vessels.

In the monitoring and logging subsystem, the monitoring and metrics collection service 361 looks up data and receives performance data from the regeneration subsystem 362. The data visualization and analytics service 363 receives a process cell subsystem log in a search engine section.

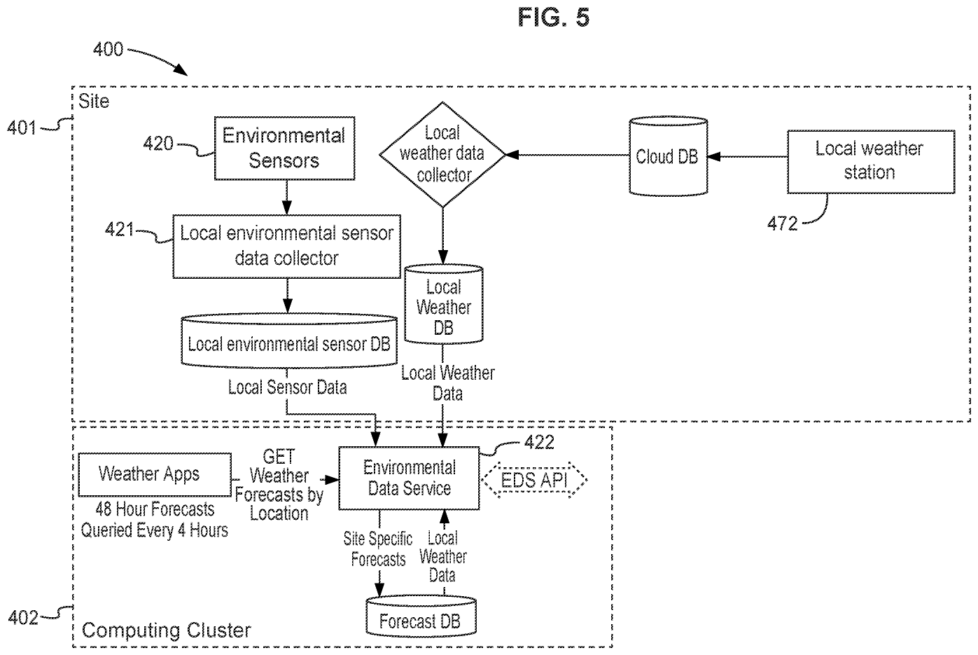

FIG. 5 is a block diagram of a system 400 for controlling water delivery to a carbonation medium, according to an embodiment. As shown, the system includes a site 401 and a computing cluster 402. In some embodiments, the site 401 and the cluster 402 can be the same or substantially similar to the site 101 and the cluster 102, as described above with reference to FIG. 2. As shown, the site 401 includes environmental sensors 420, a local environmental sensor data collector 421, and a local weather station 472. The computing cluster 402 includes an environmental data service 422.

In some embodiments, the environmental sensors 420 can be the same or substantially similar to the environmental sensors 120, as described above with reference to FIG. 2. The environmental sensors 420 communicate with the local environmental sensor data collector 421, which communicates with an local environmental sensor DB, which provides local sensor data to the environmental data service 422. The local environmental sensor data collector 421 is a supervisory control and data acquisition (SCADA) software control system used to generate a human machine interface (HMI). The local environmental sensor data collector 421 is both in the SCADA system and the HMI provider. The local weather station 472 communicates weather data. As shown by example, local weather station 472 communicates ambient weather data with a Cloud DB via Wi-Fi. The local and ambient weather data are then fed to a local weather data collector, which feeds local weather data to a local weather DB. The local weather DB fees the local weather data to the environmental data service 422.

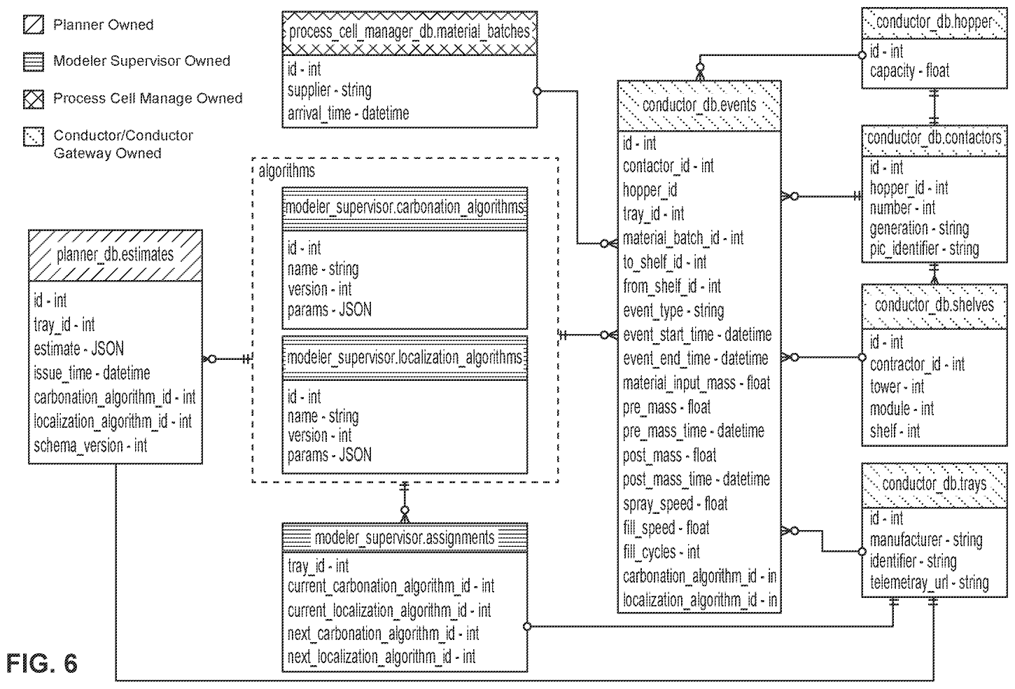

The environmental data service 422 receives weather forecasts by location from various weather apps as forecasts queried at forecasting intervals. The environmental data service 422 communicates site specific forecasts with the forecast DB and receives local weather data from the forecast DB. The environmental data service 422 includes an environmental data service application programming interface (EDS API) for interaction with the user. FIG. 6 is an entity relationship diagram of a system for controlling water delivery to a carbonation medium, according to an embodiment. Blocks with yellow headings are controlled by the conductors. The block in purple is controlled by the planner. Blocks in green are controlled by the modeler supervisor. The block in blue is controlled by the process cell manager. The modeler includes localization algorithms, evaporation algorithms, and carbonation algorithms in communication with the planner and the conductor. The modeler also includes assignments in communication with the algorithms and the trays. The planner is also in communication with the trays. The conductor database events are in communication with a tray filling system, contactors, shelves, and trays. The conductor database events are also in communication with material batches of the process cell manager. The contactors in the conductor database are also in communication with the hopper and the shelves.

Various concepts may be embodied as one or more methods, of which at least one example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments. Put differently, it is to be understood that such features may not necessarily be limited to a particular order of execution, but rather, any number of threads, processes, services, servers, and/or the like that may execute serially, asynchronously, concurrently, in parallel, simultaneously, synchronously, and/or the like in a manner consistent with the disclosure. As such, some of these features may be mutually contradictory, in that they cannot be simultaneously present in a single embodiment. Similarly, some features are applicable to one aspect of the innovations, and inapplicable to others.

In addition, the disclosure may include other innovations not presently described. Applicant reserves all rights in such innovations, including the right to embodiment such innovations, file additional applications, continuations, continuations-in-part, divisionals, and/or the like thereof. As such, it should be understood that advantages, embodiments, examples, functional, features, logical, operational, organizational, structural, topological, and/or other aspects of the disclosure are not to be considered limitations on the disclosure as defined by the embodiments or limitations on equivalents to the embodiments. Depending on the particular desires and/or characteristics of an individual and/or enterprise user, database configuration and/or relational model, data type, data transmission and/or network framework, syntax structure, and/or the like, various embodiments of the technology disclosed herein may be implemented in a manner that enables a great deal of flexibility and customization as described herein.

All definitions, as defined and used herein, should be understood to control over dictionary definitions, definitions in documents incorporated by reference, and/or ordinary meanings of the defined terms.

As used herein, in particular embodiments, the terms “about” or “approximately” when preceding a numerical value indicates the value plus or minus a range of 10%. Where a range of values is provided, it is understood that each intervening value, to the tenth of the unit of the lower limit unless the context clearly dictates otherwise, between the upper and lower limit of that range and any other stated or intervening value in that stated range is encompassed within the disclosure. That the upper and lower limits of these smaller ranges can independently be included in the smaller ranges is also encompassed within the disclosure, subject to any specifically excluded limit in the stated range. Where the stated range includes one or both of the limits, ranges excluding either or both of those included limits are also included in the disclosure.

The indefinite articles “a” and “an,” as used herein in the specification and in the embodiments, unless clearly indicated to the contrary, should be understood to mean “at least one.”

The phrase “and/or,” as used herein in the specification and in the embodiments, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the embodiments, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the embodiments, “consisting of,” will refer to the inclusion of exactly one element of a number or list of elements. In general, the term “or” as used herein shall only be interpreted as indicating exclusive alternatives (i.e., “one or the other but not both”) when preceded by terms of exclusivity, such as “either,” “one of,” “only one of,” or “exactly one of” “Consisting essentially of,” when used in the embodiments, shall have its ordinary meaning as used in the field of patent law.

As used herein in the specification and in the embodiments, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the embodiments, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

While specific embodiments of the present disclosure have been outlined above, many alternatives, modifications, and variations will be apparent to those skilled in the art. Accordingly, the embodiments set forth herein are intended to be illustrative, not limiting. Various changes may be made without departing from the spirit and scope of the disclosure. Where methods and steps described above indicate certain events occurring in a certain order, those of ordinary skill in the art having the benefit of this disclosure would recognize that the ordering of certain steps may be modified and such modification are in accordance with the variations of the invention. Additionally, certain of the steps may be performed concurrently in a parallel process when possible, as well as performed sequentially as described above. The embodiments have been particularly shown and described, but it will be understood that various changes in form and details may be made.

1. A method, comprising:
monitoring, via a first sensor, an environmental condition in a contactor unit, the contactor unit including a plurality of carbonation vessels including carbonation medium;
monitoring, via a second sensor, an environmental condition at a location outside of the contactor unit;
predicting, based on the environmental condition in the contactor unit and the environmental condition at the location outside of the contactor unit, each of a local humidity in a carbonation vessel from the plurality of carbonation vessels, a moisture content of the carbonation medium in the carbonation vessel from the plurality of carbonation vessels, and a carbonation extent of the carbonation medium in the carbonation vessel from the plurality of carbonation vessels for a carbonation forecasting period; and
executing an action on the plurality of carbonation vessels based on the predicted moisture content and predicted carbonation extent.

2. The method of claim 1, further comprising:
receiving, at a processor, current weather data from a weather service provider, wherein predicting the moisture content and carbonation extent of the carbonation medium is based on the current weather data.

3. The method of claim 2, further comprising:
receiving, at the processor, weather forecast data from a forecast provider, wherein predicting the moisture content and carbonation extent of the carbonation medium is based on the weather forecast data.

4. The method of claim 1, wherein the action includes at least one of spraying water into the carbonation vessel, humidifying the carbonation vessel, taking a measurement of the carbonation vessel, delivering water to the carbonation vessel via capillary action and/or capillary mats, stirring the carbonation medium in the carbonation vessel, dumping the carbonation medium from the carbonation vessel, or filling the carbonation vessel with carbonation medium.

5. The method of claim 1, wherein the forecasting period is between about 1 hour and about 48 hours.

6. The method of claim 3, wherein the weather service provider and the forecast provider are the same provider.

7. The method of claim 1, wherein the location outside of the contactor unit is within about 50 m of an outside border of the contactor unit.

8. The method of claim 3, wherein the weather forecast data is for a period of about 1 hour to about 96 hours.

9. The method of claim 1, further comprising:
updating the prediction of the water content and the carbonation extent of the carbonation medium at an update interval.

10. The method of claim 9, wherein the update interval is between about 5 minutes and about 12 hours.

11. The method of claim 1, wherein the current weather data includes at least one of temperature, relative humidity, wind speed, wind direction, gust speed, solar radiation and irradiance, barometric pressure, CO₂ concentration, and precipitation.

12. The method of claim 1, further comprising:
measuring, via the first sensor, at least one of carbonation vessel mass, Fourier transform infrared spectroscopy (FTIR) data from carbonation medium, temperature in the contactor unit, CO₂ concentration in the contactor unit, barometric pressure in the contactor unit, wind speed in the contactor unit, or wind direction in the contactor unit.

13. The method of claim 1, further comprising:
measuring, via the second sensor, at least one of temperature, relative humidity, or CO₂ concentration at the location outside the contactor unit.

14. The method of claim 1, further comprising:
generating a schedule for application of water to the plurality of carbonation vessels based on the predicting.

15. The method of claim 14, wherein the schedule includes a movement plan for a distributor in the contactor unit.

16. The method of claim 1, further comprising:
measuring a mass of the carbonation vessel;
providing the measured mass of the carbonation vessel, the predicted moisture content of the carbonation vessel, and the predicted carbonation extent of the carbonation medium in the carbonation vessel to a modeler; and either:
(1) transporting the carbonation vessel to a caddy for collection;
(2) translating a spray mass returned by the modeler into a spray speed and requesting the carbonation vessel be sprayed at the spray speed; or
(3) taking no action.

17. The method of claim 1, wherein the carbonation vessels include trays.

18. The method of claim 1, wherein the action includes spraying water into the carbonation vessel, and an amount of water sprayed is determined by at least one of the environmental condition at the location outside of the contactor unit, a forecasted environmental condition, a measured water content in the carbonation vessel, a forecasted water content in the carbonation vessel, a measured carbonation extent in the carbonation vessel, or a forecasted carbonation extent in the carbonation vessel.

19. A system for managing moisture content of a carbonation medium, the system comprising:
a contactor unit including a plurality of carbonation vessels with carbonation medium disposed therein;
a first sensor in the contactor unit, the first sensor configured to measure an environmental condition at a location in the contactor unit;
a second sensor outside the contactor unit, the second sensor configured to measure an environmental condition at a location outside the contactor unit, the measured environmental conditions including relative humidity;
a communication device configured to collect weather forecast data and current weather information from a weather service provider; and
a processor configured to receive data from the first sensor, the second sensor, and the communication device, the processor further configured to develop model predictions for the carbonation extent and moisture content of the carbonation medium in a carbonation vessel from the plurality of carbonation vessels and communicate instructions with components of the contactor unit based on the model predictions.

20. The system of claim 19, wherein the components of the contactor unit include at least one of a water delivery device or a distributor.

21. The system of claim 20, wherein the water delivery device includes a sprayer configured to spray water into the carbonation vessel.

22. The system of claim 19, further comprising:
a third sensor incorporated into a carbonation vessel from the plurality of carbonation vessels.

23. The system of claim 19, wherein the carbonation vessels include trays.

24. A non-transitory, processor-readable medium storing processor-executable instructions to cause a processor to:
receive, via a first sensor, environmental condition data in a contactor unit, the contactor unit including a plurality of carbonation vessels including carbonation medium;
receive, via a second sensor, environmental condition data at a location outside of the contactor unit;
predict, based on the environmental condition in the contactor unit and the environmental condition outside of the contactor unit, a water content and a carbonation extent of the carbonation medium for a carbonation forecasting period; and
cause, via an instrument, the execution of an action on the plurality of carbonation vessels based on the predicted water content and predicted carbonation extent.

25. The non-transitory, processor-readable medium of claim 24, wherein the environmental condition in the contactor unit includes at least one of relative humidity, temperature, CO₂ concentration, solar irradiance, barometric pressure, wind speed, gust speed, or wind direction.

26. The non-transitory, processor-readable medium of claim 24, wherein the environmental condition at the location outside of the contactor unit includes at least one of relative humidity, temperature, CO₂ concentration, solar irradiance, barometric pressure, wind speed, gust speed, or wind direction.

27. The non-transitory, processor-readable medium of claim 24, further storing instructions to cause the processor to receive current weather data from a weather service provider, wherein predicting the water content and the carbonation extent of the carbonation medium is based on the current weather data.

28. The non-transitory, processor-readable medium of claim 25, further storing instructions to cause the processor to receive weather forecast data from a forecast provider wherein predicting the water content and the carbonation extent of the carbonation medium is based on the weather forecast data.

29. The non-transitory, processor-readable medium of claim 24, further storing instructions to cause the processor to update predicted water content and carbonation extent at an update interval.

30. The non-transitory, process-readable medium of claim 29, wherein the update interval is between about 5 minutes and about 12 hours.

31. The non-transitory, process-readable medium of claim 24, wherein the action includes at least one of spraying water onto the carbonation vessel, stirring the carbonation medium in the carbonation vessel, dumping the carbonation medium from the carbonation vessel, or filling the carbonation vessel with carbonation medium.

32. The non-transitory, process-readable medium of claim 24, wherein the weather service provider and the forecast provider are the same provider.

33. The non-transitory, process-readable medium of claim 23, wherein the location outside of the contactor unit is within about 1 m of an outside border of the contactor unit.

34. The non-transitory, process-readable medium of claim 23, wherein the carbonation vessels include trays.
